(19) United States
(12) Patent Application Publication
(10) Pub. No.: US 2014/0341033 A1
(43) Pub. Date: Nov. 20, 2014

(54) TRANSMISSION MANAGEMENT DEVICE, SYSTEM, AND METHOD

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/278,685

(22) Filed: May 15, 2014

(30) Foreign Application Priority Data
May 16, 2013 (CN) 2013101815700

(51) Int. Cl. H04L 12/801; H04L 12/721

(52) U.S. Cl. CPC H04L 47/29; H04L 45/14
USPC 370/235

(57) ABSTRACT

A transmission management method, includes: receiving a request for establishing an on-demand virtual lease line from a first electronic device when a request is made to communicate with a second electronic device. Position information of the first electronic device and the second electronic device is obtained. Routers located between the first electronic device and the second electronic device are obtained according to position information of all routers stored in the storage unit, and the position information of the first electronic device and the second electronic device. Analyzing positions and workloads of the routers located between the first and second electronic device, and determining an optimal transmission path according to the positions and workloads of the router. The first electronic device and the second electronic device are controlled to communicate with each other via the determined optimal transmission path.

### CROSS REFERENCE TO RELATED APPLICATIONS

This application is related to the following co-pending, commonly assigned patent applications, the disclosures of which are incorporated herein by reference in their entirety:

1. “TRANSMISSION MANAGEMENT DEVICE, SYSTEM, AND METHOD” by Steve Lap Wai Hui, whose Attorney Docket No is US51795.

2. “TRANSMISSION MANAGEMENT DEVICE, SYSTEM, AND METHOD” by Steve Lap Wai Hui, whose Attorney Docket No is US51796.

3. “TRANSMISSION MANAGEMENT DEVICE, SYSTEM, AND METHOD” by Steve Lap Wai Hui, whose Attorney Docket No is US51798.

### FIELD

The present disclosure relates to devices, and particularly to a transmission management device, a system, and a method thereof.

### BACKGROUND

Electronic devices, such as mobile phones and tablet computers, are popular. Usually, the electronic devices can communicate with each other and access to a network via corresponding networks, such as internet, a code division multiple access (CDMA) network, or a broadcasting network. However, in some situations, when electronic devices connect to networks according to a certain network bandwidth assigned by a corresponding network operator, and when the number of people accessing the network is great, the resulting access speed can be very slow.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a transmission management device.

FIG. 2 is a diagram of a first embodiment of a transmission path determined by the transmission management device.

FIG. 3 is a diagram of a second embodiment of a transmission path determined by the transmission management device.

FIG. 4 is a flowchart diagram of an embodiment of a transmission management method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

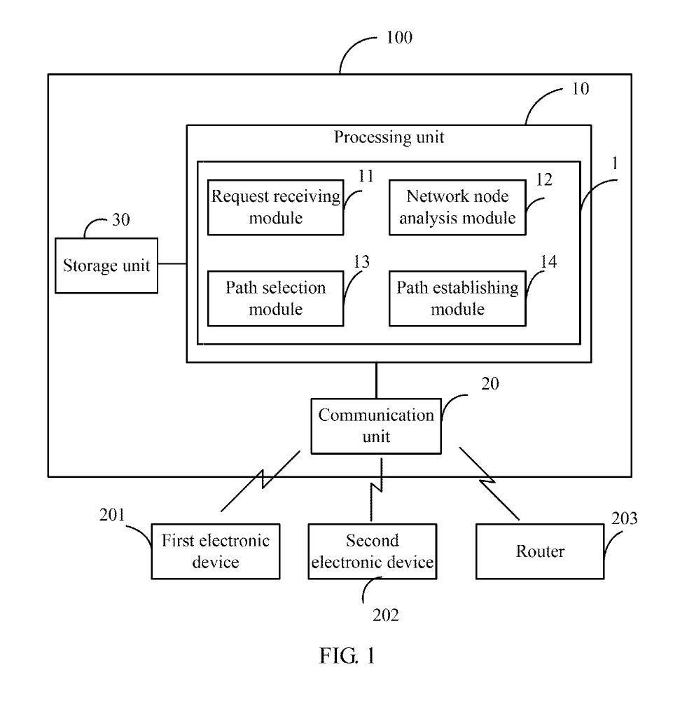

Referring to FIGS. 1-3 together, a transmission management device 100 can include a processing unit 10, a communication unit 20, and a storage unit 30.

The transmission management device 100 connects to at least one first electronic device 201, at least one second electronic device 202, and a number of routers 203 via the communication unit 203. The routers 203 respectively belong to different network operators or all belong to the same network operator. The communication unit 20 connects the transmission management device 100 with the first electronic device 201, the second electronic device 202, and the routers 203 via corresponding networks, such as, internet, a wireless network including WIFI and BLUETOOTH, a telecommunication network including a general packet radio service (GPRS) network and a code division multiple access (CDMA) network, or a broadcasting network, for example.

The storage unit 30 stores position information of each router 203. The position information of each router 203 includes a geographic position and an internet protocol (IP) address of the router 203.

In the embodiment, the storage unit 30 further stores a transmission management system 1. The transmission management system 100 includes a number of modules, which are a collection of software instructions and are executed by the processing unit 10 of the transmission management device 100. The modules include a request receiving module 11, a network node analysis module 12, a path selection module 13, and a path establishing module 14. In the embodiment, the storage unit 30 can be a hard disk, a compact disk, a flash memory, for example. The processing unit 10 can be a central processing unit, a digital processor, or a single chip, for example.

In the embodiment, the first electronic device 201 is an initiator of communication with the second electronic device 202.

The request receiving module 11 is used to receive a request for establishing an on-demand virtual lease line (ODVLL) from the first electronic device 201. In the embodiment, the request for establishing the ODVLL includes position information of the second electronic device 202, and the request for establishing the ODVLL can be produced when the first electronic device 201 requests to communicate with the second electronic device 202.

The request receiving module 11 then obtains the position information of the second electronic device 202 from the request for establishing the ODVLL, and obtains position information of the first electronic device 201 when receiving the request for establishing the ODVLL from the first electronic device 201. Obviously, when the first electronic device 100 transmits the request for establishing the ODVLL, the position information of the first electronic device 201 is easily to be obtained by the request receiving module 11, such as positioning the position of the first electronic device 201. In another embodiment, the request for establishing the ODVLL includes the position information of both of the first electronic device 201 and the second electronic device 202, the request receiving module 11 then obtains the position information of the first electronic device 201 and the second electronic device 202 according to the request for establishing the ODVLL. In the embodiment, the position information of the first electronic device 201 includes a geographic position and an IP address of the first electronic device 201, and the position information of the second electronic device 202 includes a geographic position and an IP address of the second electronic device 202.

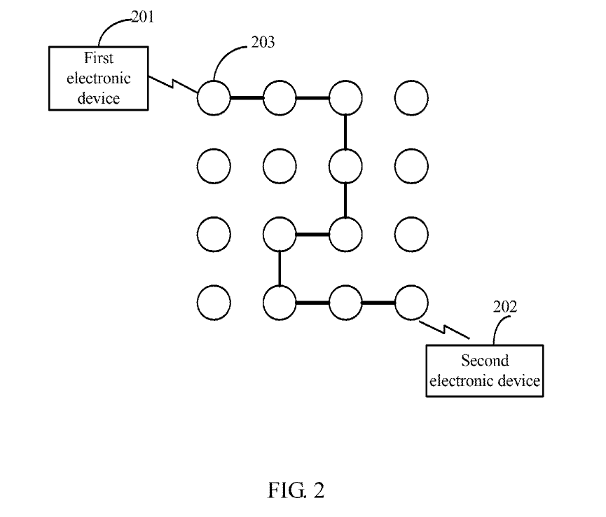

FIG. 2 shows that the network node analysis module 12 determines routers 203 located between the first electronic device 201 and the second electronic device 202 according to the position information of the routers 203 stored in the storage unit 30, and the obtained position information of the first electronic device 201 and the second electronic device 202. As shown in FIG. 2, the routers 203 that are located between the first electronic device 201 and the second electronic device 202 constitute a number of network nodes between the first electronic device 201 and the second electronic device 202. In the embodiment, the network node analysis module 12 determines all routers 203 located between the first electronic device 201 and the second electronic device 202 at one time according to the position information of the routers 203 stored in the storage unit 30, and the obtained position information of the first electronic device 201 and the second electronic device 202.

In the embodiment, the routers 203 located between the first electronic device 201 and the second electronic device 202 are routers 203 with geographic positions between the geographic positions of the first electronic device 201 and the second electronic device 202.

The path selection module 13 is used to analyze positions and workloads of the routers 203 located between the first electronic device 201 and the second electronic device 202, and determine an optimal transmission path according to the positions and workloads of the routers 203 located between the first electronic device 201 and the second electronic device 202. In detail, the path selection module 13 determines the routers 203 with workloads less than a predetermined value, and selects a minimum number of determined routers 203 to form the optimal transmission path between the first electronic device 201 and the second electronic device 202. In detail, after the path selection module 13 determines all of the routers 203 with a workload less than the predetermined value, a number of transmission paths are determined, each consisted by several determined routers 203 adjacent to each other one by one, and then a transmission path including the minimum routers 203 is determined as the optimal transmission path also by the path selection module 13.

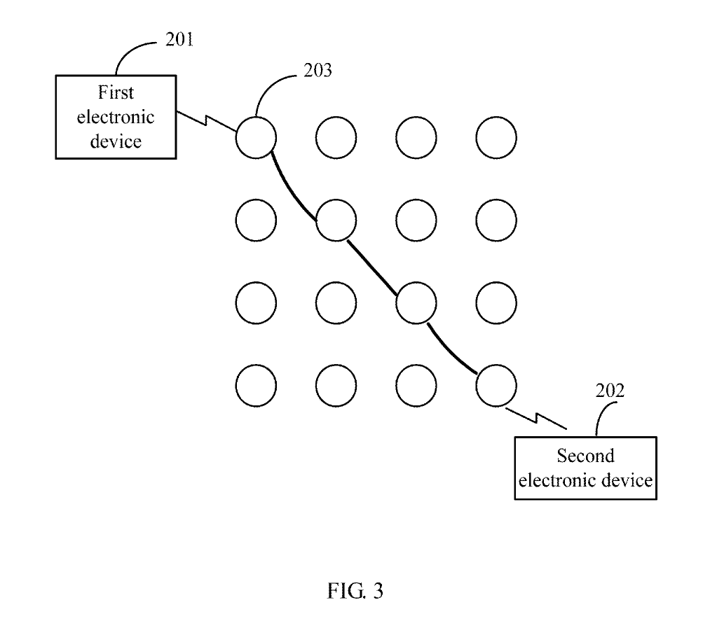

For example, FIG. 3 shows that if the workloads of the routers 203 located between the first electronic device 201 and the second electronic device 202 are all less than the predetermined value, the path selection module 13 determines the diagonal line of the graphic consisted of all of the routers 203 as the shortest transmission path. Then selects the routers 203 located on the diagonal line to form the optimal transmission path between the first electronic device 201 and the second electronic device 202.

In the embodiment, the workload of the router 203 includes a network utilization ratio, a processing load of the router 203, for example. The network utilization ratio is the ratio of a current network traffic of the router 203 to the maximum network traffic that the router 203 can handle. When more data is transmitted/received and processed by one router 203, the network utilization ratio is greater, and the workload of the router 203 is heavy. In the embodiment, the path selection module 13 determines the network utilization ratio is less than the predetermined value thus determining the workload of the router 203 is less than the predetermined value. In the embodiment, the predetermined value is 50%.

The path establishing module 14 controls the first electronic device 201 and the second electronic device 202 to communicate with each other via the optimal transmission path according to the optimal transmission path determined by the path selection module 13. Thus, the first electronic device 201 and the second electronic device 202 are assigned to the ODVLL accordingly.

Thus, because the routers 203 whose workloads are less than the predetermined value constitute the optimal transmission path, then the transmission speed between the first electronic device 201 and the second electronic device 202 is enhanced.

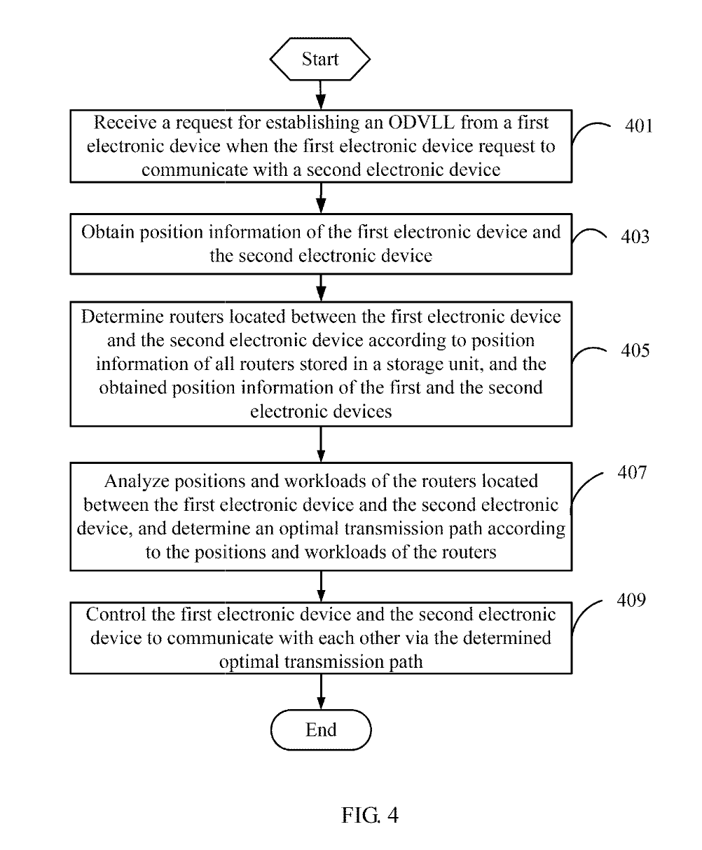

FIG. 4 shows a flowchart of a transmission management method. In 401, the request receiving module receives a request for establishing an on-demand virtual lease line (ODVLL) from the first electronic device. In one embodiment, the request for establishing the ODVLL includes position information of the first electronic device and the second electronic device. In addition, the request for establishing the ODVLL is produced by operating a particular button or a particular item in responses to manual operation when the first electronic device requests communication with the second electronic device.

In 403, the request receiving module obtains the position information of the first electronic device and the second electronic device from the request for establishing the ODVLL.

In 405, the network node analysis module determines routers located between the first electronic device and the second electronic device according to the position information of the routers stored in the storage unit, and the obtained position information of the first electronic device and the second electronic device. In the embodiment, the network node analysis module determines the routers with geographic positions located in an area between the geographic positions of the first electronic device and the second electronic device.

In 407, the path selection module analyzes positions and workloads of the routers located between the first electronic device and the second electronic device, and determines a optimal transmission path according to the positions and workloads of the routers located between the first electronic device and the second electronic device. In the embodiment, the path selection module determines the routers with workloads less than a predetermined value, and selects least adjacent routers with workloads less than the predetermined value to form the optimal transmission path between the first electronic device and the second electronic device.

In 409, the path establishing module controls the first electronic device and the second electronic device to communicate with each other via the optimal transmission path determined by the path selection module.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission management system, applied to a transmission management device comprising a communication unit for connecting to a plurality of routers and a storage unit for storing position information of the plurality of routers, the transmission management system comprising:
a processing unit;
a plurality of modules which are collections of instructions executed by the processing unit, the modules comprising:
a request receiving module, configured to receive a request for establishing an on-demand virtual lease line (ODVLL) with a first electronic device when the first electronic device requests to communicate with a second electronic device, and further configured to obtain position information of the first electronic device and the second electronic device;
a network node analysis module configured to determine routers located between the first electronic device and the second electronic device according to position information of the plurality of routers stored in the storage unit, and the obtained position information of the first electronic device and the second electronic device;
a path selection module configured to analyze positions and workloads of the routers located between the first electronic device and the second electronic device, and configured to determine a optimal transmission path according to the positions and workloads of the routers located between the first electronic device and the second electronic device; and
a path establishing module configured to control the first electronic device and the second electronic device to communicate with each other via the optimal transmission path determined by the path selection module.

2. The system according to claim 1, wherein the position information of the first electronic device comprises a geographic position of the first electronic device, the position information of the second electronic device comprises a geographic position of the second electronic device, and the position information of the routers comprises geographic positions of the routers, the routers located between the first electronic device and the second electronic device are those router with geographic positions between the geographic positions of the first electronic device and the second electronic device.

3. The system according to claim 1, wherein the path selection module determines the routers with workload less than a predetermined value, and selects a minimum number of determined routers adjacent to each other to form the optimal transmission path between the first electronic device and the second electronic device.

4. The system according to claim 3, wherein the workload of each router comprises a network utilization ratio of the router, and the path selection module determines the workload of the router is less than the predetermined value by determining the network utilization ratio is less than the predetermined value.

5. The system according to claim 1, wherein the request for establishing the ODVLL comprises the position information of the first electronic device and the second electronic device, the request receiving module obtains the position information of the first electronic device and the second electronic device from the request for establishing the ODVLL.

6. A transmission management device comprising:
a communication unit configured to communicate with at least one first electronic device, at least one second electronic device, and a plurality of routers;
a storage unit configured to store position information of the plurality of routers;
a processing unit configured to execute a plurality of modules which are collection of instructions, the modules comprising:
a request receiving module, configured to receive a request for establishing an on-demand virtual lease line (ODVLL) from a first electronic device when the first electronic device request to communicate with a second electronic device, and obtain position information of the first electronic device and the second electronic device;
a network node analysis module configured to determine routers located between the first electronic device and the second electronic device according to position information of all routers stored in the storage unit, and the obtained position information of the first electronic device and the second electronic device;
a path selection module configured to analyze positions and workloads of the routers located between the first electronic device and the second electronic device, and determine a optimal transmission path according to the positions and workloads of the routers located between the first electronic device and the second electronic device; and
a path establishing module configured to control the first electronic device and the second electronic device to communicate with each other via the optimal transmission path determined by the path selection module.

7. The device according to claim 6, wherein the he position information of the first electronic device comprises a geographic position of the first electronic device, the position information of the second electronic device comprises a geographic position of the second electronic device, and the position information of the routers comprises geographic positions of the routers, the routers located between the first electronic device and the second electronic device are those router with geographic positions between the geographic positions of the first electronic device and the second electronic device.

8. The device according to claim 6, wherein the path selection module determines the routers with workload less than a predetermined value, and selects a least number of determined routers adjacent to each other to form the optimal transmission path between the first electronic device and the second electronic device.

9. The device according to claim 8, wherein the workload of each router comprises a network utilization ratio of the router, and the path selection module determines the workload of the router is less than the predetermined value by determining the network utilization ratio is less than the predetermined value.

10. The system according to claim 6, wherein the transmission management device is a network server, and the routers connected to the transmission management device via the communication unit belong to different network operators.

11. The device according to claim 6, wherein the request for establishing the ODVLL comprises the position information of the first electronic device and the second electronic device, the request receiving module obtains the position information of the first electronic device and the second electronic device from the request for establishing the ODVLL.

12. A transmission management method, applied to a transmission management device comprising a storage unit, the method comprising:
receiving a request for establishing an on-demand virtual lease line (ODVLL) from a first electronic device when the first electronic device request to communicate with a second electronic device;
obtaining position information of the first electronic device and the second electronic device;
determining routers located between the first electronic device and the second electronic device according to position information of all routers stored in the storage unit, and the obtained position information of the first electronic device and the second electronic device;
analyzing positions and workloads of the routers located between the first electronic device and the second electronic device, and determining a optimal transmission path according to the positions and workloads of the routers located between the first electronic device and the second electronic device; and
controlling the first electronic device and the second electronic device to communicate with each other via the determined optimal transmission path.

13. The method according to claim 12, wherein the step of determining routers located between the first electronic device and the second electronic device according to position information of all routers stored in the storage unit, and the obtained position information of the first electronic device and the second electronic device comprises:
determining routers with geographic positions between geographic positions of the first electronic device and the second electronic device according to position information of all routers stored in the storage unit, and the obtained position information of the first electronic device and the second electronic device.

14. The method according to claim 12, wherein the step of analyzing positions and workloads of the routers located between the first electronic device and the second electronic device, and determining a optimal transmission path according to the positions and workloads of the routers located between the first electronic device and the second electronic device comprises:
analyzing positions and workloads of the routers located between the first electronic device and the second electronic device;
determining the routers with workloads less than a predetermined value; and
selecting a least number of determined routers adjacent to each other to form the optimal transmission path between the first electronic device and the second electronic device.

15. The method according to claim 14, wherein the workload of each router comprises a network utilization ratio of the router, the step of analyzing workloads of the routers located between the first electronic device and the second electronic device comprises:
determining the workload of the router is less than the predetermined value by determining the network utilization ratio is less than the predetermined value.

16. The method according to claim 12, wherein the request for establishing the ODVLL comprises the position information of the first electronic device and the second electronic device, the step of obtaining position information of the first electronic device and the second electronic device comprises:
obtaining position information of the first electronic device and the second electronic device from the request for establishing the ODVLL.
